(19) United States
(12) Patent Application Publication
(10) Pub. No.: US 2026/0284781 A1
(43) Pub. Date: Sep. 24, 2026

(54) APPARATUS FOR DIGITAL SPOT LASER PROCESSING AND APPLICATION THEREOF

(71) Applicant: ZHEJIANG UNIVERSITY OF TECHNOLOGY, Hangzhou (CN)

(72) Inventors: Jianhua YAO, Hangzhou (CN); Qunli ZHANG, Hangzhou (CN); Siyuan XIANG, Hangzhou (CN); Zhijun CHEN, Hangzhou (CN); Hang ZHANG, Hangzhou (CN); Liang WANG, Hangzhou (CN); Bo LI, Hangzhou (CN); Zhehe YAO, Hangzhou (CN); Jiake DENG, Hangzhou (CN)

(73) Assignee: ZHEJIANG UNIVERSITY OF TECHNOLOGY, Hangzhou (CN)

(21) Appl. No.: 19/570,149

(22) Filed: Mar. 17, 2026

(30) Foreign Application Priority Data
Mar. 18, 2025 (CN) 202510317578.8

(51) Int. Cl. B23K 26/03; B23K 26/04

(52) U.S. Cl. CPC B23K 26/032; B23K 26/034; B23K 26/04

(57) ABSTRACT

The present disclosure relates to an apparatus for digital spot laser processing and an application thereof. The apparatus includes a laser processing lens and a thermal imager arranged in coordination. The laser processing lens receives arrayed laser beams from a light entrance port. A collimation module is configured to perform a collimation process on the arrayed laser beams. A microlens array homogenizing and shaping module performs an output spot regularization process on each laser beam in the arrayed laser beams. A light exit port outputs processed arrayed laser spots. A controller is provided in coordination with laser beams from a laser emitter array and the thermal imager. The controller adjusts a partitioned output of the laser emitter array based on a feedback signal from the thermal imager. The laser processing lens is applied to laser processing of components having symmetrical heat transfer characteristics and components having asymmetrical heat transfer characteristics.

### CROSS-REFERENCE TO RELATED APPLICATIONS

This application claims priority to the Chinese Patent Application No. 202510317578.8, filed on Mar. 18, 2025, the contents of which are hereby incorporated by reference.

### TECHNICAL FIELD

The present disclosure generally relates to a field of brazing or desoldering; welding; cladding or plating by brazing or welding; local heating cutting, such as flame cutting; and processing with a laser beam, and in particular, to an apparatus for digital spot laser processing and an application thereof.

### BACKGROUND

Laser processing utilizes the energy of light, which, after being focused by a lens, achieves a very high energy density at a focal point. This enables various processing purposes for a plurality of metal and non-metal materials, including the processing of materials with high hardness, high brittleness, and high melting points.

During laser processing, a category of complex components, which includes but is not limited to, blades, rails, bearings, or the like, presents particular difficulty due to asymmetric heat transfer characteristics, such as variable cross-sections, special-shaped surfaces, and variable curvature. After the complex components are subjected to service conditions such as alternating heavy loads, frequent impacts, and fatigue wear, how to improve surface performance, repair damaged parts, and improve service life through laser processing becomes an urgent problem to be solved.

### SUMMARY

The present disclosure provides an apparatus for digital spot laser processing and an application thereof. The apparatus for digital spot laser processing can perform laser large-area strengthening on a complex component, which ensures consistency of a surface temperature, thereby improving processing quality and efficiency.

One or more embodiments of the present disclosure provides an apparatus for digital spot laser processing. The apparatus for digital spot laser processing includes a laser processing lens and a thermal imager arranged in coordination. The laser processing lens includes a light entrance port, arranged in coordination with a laser emitter array for receiving laser beams from the laser emitter array, a collimation module configured to perform a collimation process on each of the laser beams input from the light entrance port; a microlens array homogenizing and shaping module configured to perform an output spot regularization process on each of the laser beams after the collimation process; a light exit port configured to output processed arrayed laser spots; wherein the light entrance port, the collimation module, the microlens array homogenizing and shaping module, and the light exit port are sequentially arranged in coordination; a controller arranged in coordination with the laser beams from the laser emitter array and the thermal imager; wherein the controller adjusts a partitioned output of the laser emitter array based on a feedback signal from the thermal imager; the laser emitter array includes laser emitters arranged in an array, each of the laser emitters is provided with a corresponding sub-controller, and all sub-controllers corresponding to the laser emitters cooperate with the controller; for an irradiation region corresponding to any one of the laser beams, a temperature deviation rate

$$\frac{e}{{T}_{0}}$$

is acquired, where e is a deviation between a preset temperature value and a measured value, and when

$$\frac{e}{{T}_{0}}$$

is greater than a preset value, a sub-controller corresponding to a laser beam adjacent to a current laser beam performs synchronous power adjustment, and a priority of the synchronous power adjustment is higher than a priority of a corresponding proportional-integral-derivative (PID) instruction.

### BRIEF DESCRIPTION OF THE DRAWINGS

FIG. 1 is a schematic structural diagram of a laser processing lens according to some embodiments of the present disclosure.

FIG. 2 is a schematic diagram of an optical path of a laser processing lens according to some embodiments of the present disclosure.

FIG. 3 is a schematic diagram of the microlens array homogenizing and shaping module according to some embodiments of the present disclosure.

FIG. 4 is a flowchart of controlling an output of a sub-controller according to some embodiments of the present disclosure.

FIG. 5 is an application schematic diagram of an apparatus for digital spot laser processing according to some embodiments of the present disclosure.

FIG. 6 is an application flowchart of the apparatus for digital spot laser processing according to some embodiments of the present disclosure.

FIG. 7 is a schematic diagram of an effect of enabling or disabling unit spot light output for different regions according to some embodiments of the present disclosure, wherein (a) is an original workpiece, (b) is a top view of the original workpiece, (c) is a schematic diagram of spots in different regions of a workpiece during processing, and (d) is a top view of (c).

### DETAILED DESCRIPTION

The present disclosure is described in further detail below in conjunction with embodiments, but the scope of protection of the present disclosure is not limited thereto.

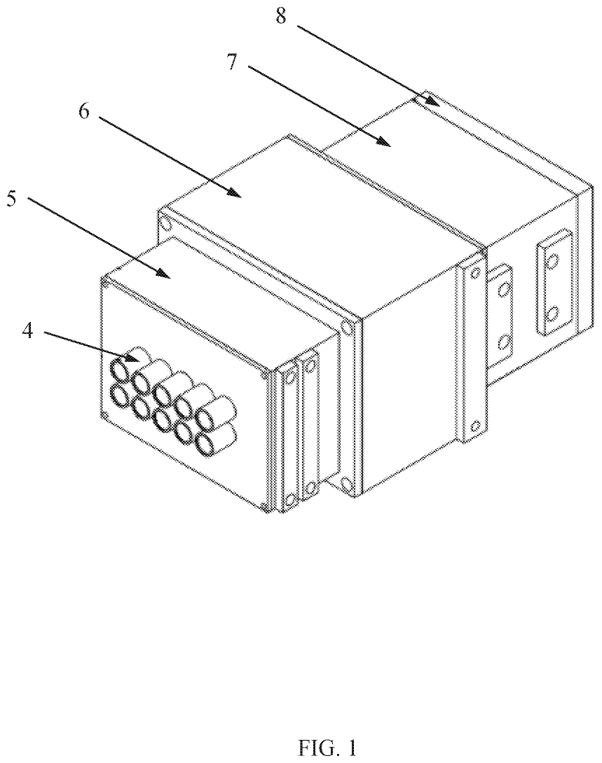

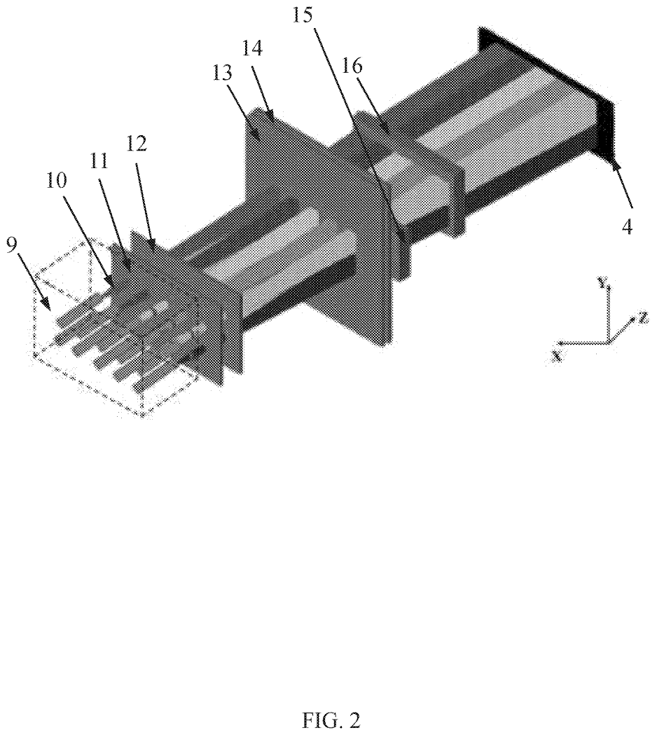

FIG. 1 is a schematic structural diagram of a laser processing lens according to some embodiments of the present disclosure. FIG. 2 is a schematic diagram of an optical path of the laser processing lens according to some embodiments of the present disclosure.

As shown in FIG. 1 and FIG. 2, the present disclosure relates to an apparatus for digital spot laser processing. The apparatus for digital spot laser processing includes a laser processing lens 2 and a thermal imager 17 arranged in coordination. The laser processing lens 2 includes a light entrance port, arranged in coordination with a laser emitter array 9 for receiving laser beams from the laser emitter array 9 (arrayed laser beams), a collimation module 4 configured to perform a collimation process on each of the laser beams input from the light entrance port; a microlens array homogenizing and shaping module configured to perform an output spot regularization process on each of the laser beams after the collimation process; and a light exit port 8 configured to output processed arrayed laser spots. The light entrance port, the collimation module 4, the microlens array homogenizing and shaping module, and the light exit port 8 are sequentially arranged in coordination. A controller 1 is provided in coordination with the laser beams from the laser emitter array 9 and the thermal imager 17. The controller 1 adjusts a partitioned output of the laser emitter array 9 based on a feedback signal from the thermal imager 17. The laser emitter array 9 includes laser emitters arranged in an array. For an irradiation region corresponding to any one of the laser beams, a temperature deviation rate

$$\frac{e}{{T}_{0}}$$

is acquired, where e is a deviation between a preset temperature value and a measured value. When

$$\frac{e}{{T}_{0}}$$

is greater than a preset value, a sub-controller corresponding to a laser beam adjacent to a current laser beam performs synchronous power adjustment, and a priority of the synchronous power adjustment is higher than a priority of a corresponding PID instruction.

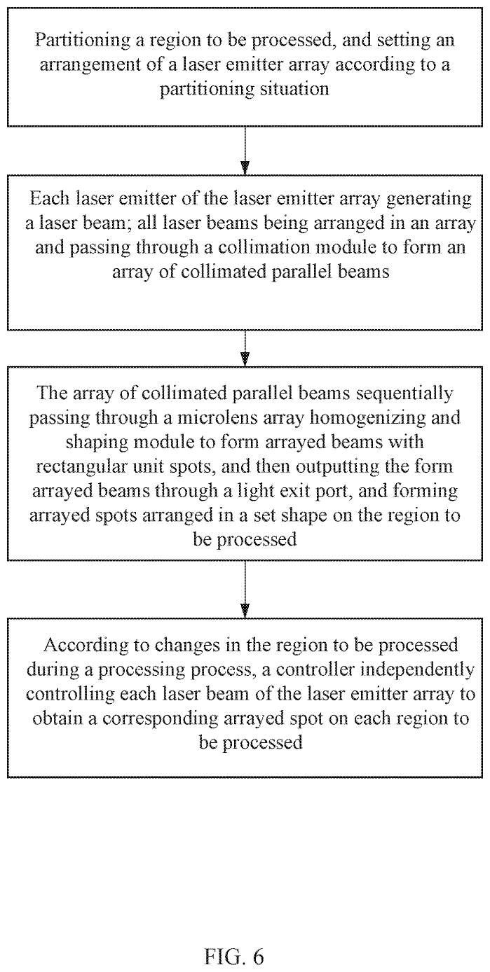

In some embodiments, the laser emitter array is connected to the laser processing lens via an optical fiber. The laser processing lens is fixed to a spindle of a machine tool. The thermal imager is fixed to a side of the laser processing lens. A working field of view of the laser processing lens and a working field of view of the thermal imager both face a workpiece to be processed. The controller 1 is connected to the thermal imager and the laser emitter array via signal lines. For a description of the workpiece to be processed, refer to related content in FIG. 6.

The apparatus for digital spot laser processing is a device that processes the workpiece to be processed by utilizing an interaction between laser beams and materials.

The laser emitter array 9 is a device that generates an array of a plurality of laser beams (arrayed laser beams).

In some embodiments, the laser emitter array 9 includes a plurality of laser emitters arranged in an array.

The laser emitter is a device that generates and emits an independent laser beam, for example, a fiber laser.

Each individual laser emitter is referred to as a unit laser.

In some embodiments, the laser processing device includes the laser processing lens 2 and the thermal imager 17 arranged in coordination.

In some embodiments, the laser emitter array 9 is connected to the laser processing lens 2 via an optical fiber. The laser beam enters an internal optical path of the laser processing lens 2 along the optical fiber.

The laser processing lens 2 is a core optical component of the laser processing device.

The laser processing lens 2 is configured to convert a plurality of laser beams generated by the laser emitter array 9 into arrayed laser spots.

The arrayed laser spots refer to a spot array formed by a plurality of laser spots on a same plane according to a preset rule. The preset rule refers to an arrangement manner of laser spots preset manually, e.g., a 3×3 matrix arrangement.

Each laser beam corresponds to one laser spot. Each individual laser spot is also referred to as a unit spot.

In the laser processing lens 2, an end where the laser beam enters is an incidence end, and an end where the arrayed laser spots exit is an exit end.

In some embodiments, the laser processing lens 2 includes the light entrance port, the collimation module 4, the microlens array homogenizing and shaping module, and the light exit port 8.

The light entrance port is an optical interface of the laser processing lens for receiving the laser beams.

The light entrance port is disposed at the incidence end of the laser processing lens. For example, the light entrance port is an opening provided at an incidence end of a housing of the laser processing lens.

The light entrance port is configured to receive the arrayed laser beams emitted by the laser emitter array 9.

In some embodiments, the light entrance port is arranged in coordination with the laser emitter array 9. For example, the light entrance port has a same shape as the laser emitter array 9, and a size of the light entrance port is larger than a size of the laser emitter array 9.

In some embodiments, the light entrance port is connected to an optical fiber interface of the laser emitter array 9.

The collimation module 4 is an optical system that adjusts a divergence of the laser beam, e.g., an aspheric lens.

In some embodiments, the collimation module 4 is disposed adjacent to the light entrance port and is fixed inside the housing of the laser processing lens via a connection way such as threaded connection or adhesive bonding.

The collimation module 4 is configured to perform a collimation process on each laser beam input from the light entrance port. The collimation process refers to converting divergent laser beams into approximately parallel laser beams.

The microlens array homogenizing and shaping module is an optical system that performs energy redistribution and shape modification on the laser beam, e.g., a flying focal lens array.

In some embodiments, the microlens array homogenizing and shaping module is disposed between the collimation module 4 and the light exit port 8. The microlens array homogenizing and shaping module is fixed inside the housing of the laser processing lens by a connection way such as threaded connection or adhesive bonding.

The microlens array homogenizing and shaping module is configured to perform an output spot regularization process on each laser beam after the collimation process.

The output spot regularization refers to converting laser spots with irregular shapes or a Gaussian distribution into laser spots with a regular shape and uniform intensity. The laser spots are arranged as arrayed laser spots according to the preset rule.

The light exit port 8 is an optical interface of the laser processing lens for outputting the arrayed laser spots.

The light exit port 8 is disposed at the exit end of the laser processing lens. For example, the light exit port 8 is an opening provided at an exit end of the housing of the laser processing lens.

The light exit port 8 is configured to output the arrayed laser spots processed by the collimation module and the microlens array homogenizing and shaping module.

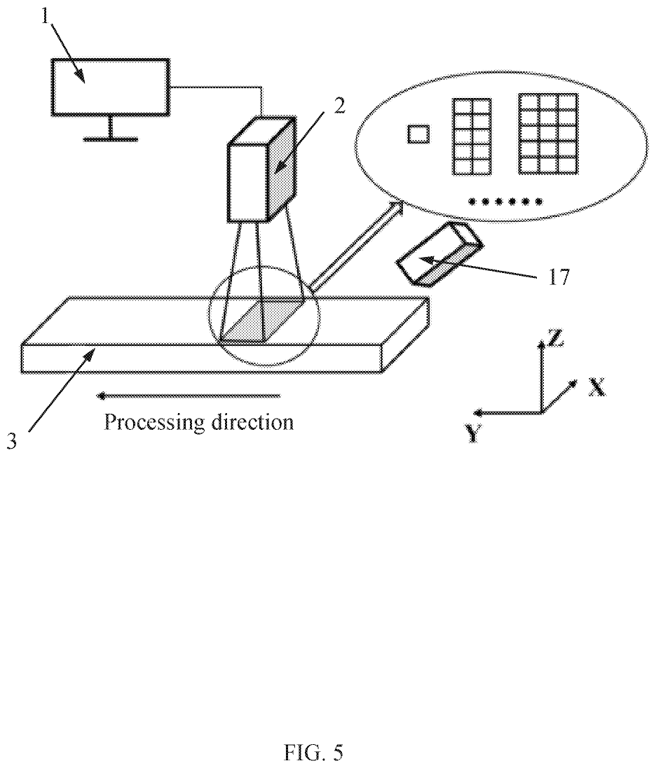

In some embodiments, the light exit port 8 faces a workpiece to be processed 3. More descriptions regarding the workpiece to be processed 3 may be found in related content of FIG. 5 and FIG. 6.

In some embodiments, the light entrance port, the collimation module 4, the microlens array homogenizing and shaping module, and the light exit port 8 are sequentially and cooperatively arranged.

In some embodiments, the light entrance port and the light exit port are openings of the housing of the laser processing lens at the incidence end and the exit end, respectively. The collimation module 4 and the microlens array homogenizing and shaping module are sequentially installed inside the housing of the laser processing lens by connection ways such as threaded connection or adhesive bonding.

In some embodiments, exit end faces of all of the laser emitters are flush, and all of the laser beams output from all of the laser emitters are parallel. The collimation module includes collimating lenses 10 arranged in one-to-one correspondence and coaxial with the laser emitters, all of the collimating lenses 10 are parallel, incidence ends of all of the collimating lenses 10 are flush, and exit ends of all of the collimating lenses 10 are flush. A water cooling unit is provided for each of the laser emitters.

The exit end face refers to a surface from which a laser beam is emitted from inside the laser emitter.

In some embodiments, the laser emitter array 9 includes a plurality of fiber laser emitters. Exit end faces of all of the fiber laser emitters are in a same plane and are arranged according to a set array.

In some embodiments, the set array of the laser emitters is in a range of 1×1 to 3×5.

In some embodiments, all of the collimating lenses 10 are arranged in the set array in a same plane, and are disposed in one-to-one coaxial correspondence with the laser emitters. For example, all of the laser emitters are respectively fixed to corresponding collimating lenses 10 via optical fiber interfaces in a one-to-one manner.

In some embodiments, all of laser emitters are arranged in the set array in a same plane and are fixed on a bracket. All of the collimating lenses 10 are arranged in the same set array in a same plane and are fixed on another bracket. The two brackets are connected so that the collimating lenses 10 correspond to the laser emitters in the one-to-one manner, thereby achieving rapid installation and alignment.

In some embodiments, the light exit port 8 includes an output protection window disposed corresponding to the laser emitter array 9.

In some embodiments, the collimating lens 10 is matched with a corresponding protection window.

Both the output protection window and the protection window are components for protecting beam output quality from being affected, for example, a glass sheet coated with an anti-reflection film.

In some embodiments, the output protection window is installed on the light exit port.

In some embodiments, the protection window is installed at the exit end of the collimating lens 10.

The output protection window disposed corresponding to the light exit port 8 is similar to the protection window corresponding to the collimating lens 10. This is content easily understood by a person skilled in the art.

The water cooling unit refers to a unit that uses a liquid as a medium to cool down equipment, for example, a laser chiller or a water cooling plate. The water cooling unit is configured to cool down the laser emitter.

In some embodiments, the laser emitters are fixed on one side of the bracket in the set array. The water cooling plate is fixed on another side of the bracket. The water cooling plate is adjacent to the laser emitters and cools down the laser emitters.

In some embodiments of the present disclosure, all laser beams are parallel and the exit end faces are flush, thereby improving optical path consistency. The laser emitters are installed with the water cooling unit, which ensures stability of equipment operation.

The controller 1 is a control center of the apparatus for digital spot laser processing. For example, the controller 1 is an independent electrical control cabinet or a computer.

In some embodiments, the controller 1 is respectively in signal connection with the laser emitter array 9 and the thermal imager. The controller 1 is configured to obtain temperature data of the workpiece to be processed and output a corresponding power control instruction to the laser emitter array 9.

In some embodiments, a corresponding sub-controller is provided for any laser emitter. All sub-controllers cooperate with the controller 1.

The sub-controller is a local control unit of the apparatus for digital spot laser processing, for example, a microcontroller.

The sub-controller is configured to receive a power control instruction from the controller, and adjust a corresponding unit laser power based on the power control instruction. Descriptions regarding the power control instruction may be found in related descriptions below.

In some embodiments, the controller 1 is configured for temperature control. An infrared thermal imager is set up to monitor a temperature of a surface of the workpiece to be processed 3 in real time and transmit the temperature to the controller 1. The controller 1 compares the temperature with a set temperature threshold, then controls the sub-controller to adjust the unit laser power.

The unit laser power refers to a power corresponding to a unit laser emitter.

In some embodiments, the controller 1 is configured to adjust the partitioned output of the laser emitter array 9 based on the feedback signal from the thermal imager 17.

The partitioned output means that the laser emitter array is divided into a plurality of independently regulated partitions, and emits laser beams on a per-partition basis.

### Descriptions Regarding a Division Way of the Partitions May be Found in Related Content of Step S1.1.

In some embodiments, the controller 1 receives the feedback signal from the thermal imager 17, obtains temperature data of each partition based on the feedback signal, determines a partition requiring temperature adjustment based on the temperature data, and generates a corresponding power control instruction and sends the power control instruction to a corresponding sub-controller. The sub-controller adjusts an output power of a laser emitter in the corresponding partition.

More descriptions regarding the division way of the partitions and the way of partitioned output may be found in related content of step S1.1.

In some embodiments, the thermal imager 17 and the laser processing lens 2 are disposed on a same side of the workpiece 3. A field of view of the thermal imager 17 covers an entire region to be processed of the workpiece to be processed 3.

Descriptions regarding the workpiece to be processed 3 and the region to be processed may be found in related content of FIG. 6.

The thermal imager 17 is configured to collect temperature data of the surface of the workpiece to be processed 3 in real time, and generates the feedback signal and uploads the feedback signal to the controller 1. The feedback signal is information transmitted by the thermal imager 17 to the controller 1.

In some embodiments, the feedback signal includes temperature data of the workpiece to be processed. For example, the feedback signal includes an infrared image of the surface of the workpiece to be processed 3 captured by the thermal imager in real time.

In some embodiments, the thermal imager 17 is electrically connected to the controller 1 via a signal line, the controller 1 is communicatively connected to the sub-controllers via Ethernet or the like, and each of the sub-controllers corresponds to a laser emitter in the laser emitter array. The controller 1 receives the feedback signal uploaded by the thermal imager 17, generates a power control instruction based on the feedback signal, and sends the power control instruction to a corresponding sub-controller. The sub-controllers independently adjust an output power of a corresponding laser emitter based on the received power control instruction. For example, when determining, based on the feedback signal from the thermal imager, that a temperature of an irradiation region of a No. 3 unit spot is too high, the controller 1 generates a power adjustment instruction “reduce the output power of the No. 3 laser emitter to 20% of the current output power” and sends the instruction to the No. 3 sub-controller via Ethernet. After receiving the instruction, the No. 3 sub-controller reduces the output power of the No. 3 laser emitter to 20% of the current output power.

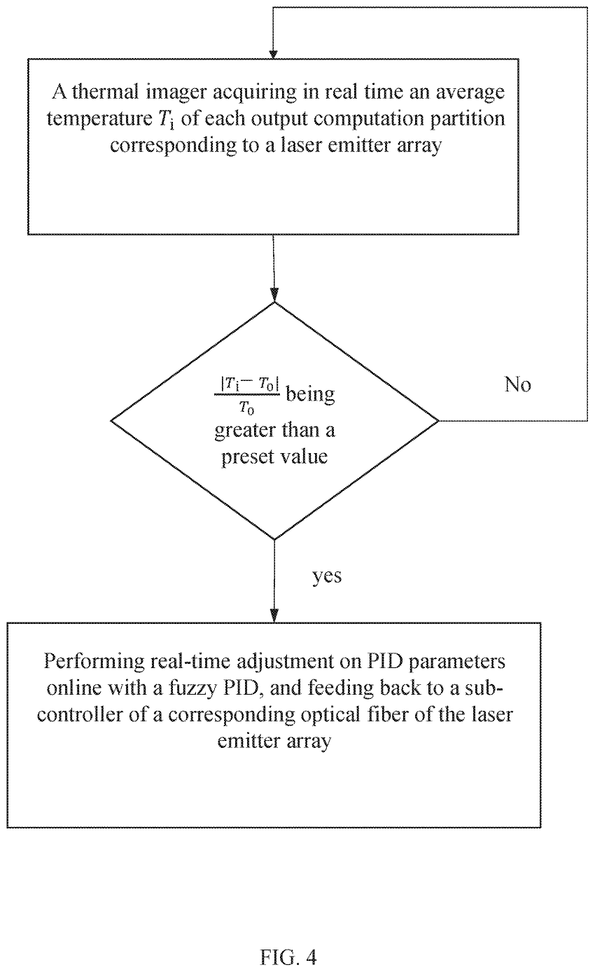

FIG. 4 is a flowchart of controlling an output of a sub-controller according to some embodiments of the present disclosure. FIG. 5 is an application schematic diagram of an apparatus for digital spot laser processing according to some embodiments of the present disclosure.

As shown in FIG. 4 and FIG. 5, a processing start coordinate (x₀, 0) and a processing stroke x are set according to a size of the workpiece to be processed 3.

In some embodiments, a process for controlling, by the controller, the sub-controller to output includes the following steps, which are performed by the controller.

S1.1, the thermal imager acquiring in real time an average temperature Tᵢ of each output computation partition corresponding to the laser emitter array.

In some embodiments, the controller maps pixel areas in an infrared image of a region to be processed one-to-one to irradiation regions of unit spots in the arrayed laser spot. For example, for a 2×5 arrayed laser spot, the region to be processed is divided into 10 output computation partitions that are one-to-one mapped to unit spots.

The irradiation region refers to a region on a surface of the workpiece to be processed that is actually irradiated by the laser beam and where a thermal effect is generated. The output computation partition is a computation unit for the controller to calculate the average temperature.

Each unit spot in the arrayed laser spot is formed by a laser emitter in the laser emitter array via a corresponding optical fiber and irradiates a sub-region in the region to be processed. The controller sets a corresponding output computation partition for each unit spot to obtain temperature data of the irradiation region and to independently control an output power of the corresponding laser emitter.

In some embodiments, the thermal imager monitors and collects a surface temperature of each output computation partition in real time and calculates the average temperature Tᵢ of the output computation partition of the region to be processed according to a temperature transfer function G₀(s).

In some embodiments, the temperature transfer function G₀(s) for laser processing is a first-order transfer function, which satisfies Formula (1):

$${G}_{0} ( s ) = \frac{K}{sT + 1} \qquad ( 1 )$$

where K is a system gain coefficient representing an output value after the system stabilizes; T is a time constant representing a time required for the system to rise to 0.623K; s is a complex variable representing a frequency response of the system.

In some embodiments, the temperature data collected by the thermal imager is curve-fitted via Newton interpolation to obtain K=0.217, T=2.84.

S1.2, based on the Tᵢ and a preset temperature threshold T₀, if

$$\frac{\vert {T}_{i} - {T}_{0} \vert}{{T}_{0}}$$

is greater than a preset value, proceeding to S1.3, otherwise, repeat S1.1.

The temperature threshold T₀ is a temperature desired to be achieved during laser processing, which is preset based on historical experience.

The preset value refers to an allowable range of a relative temperature deviation, which is preset based on historical experience.

In some embodiments, the calculated average temperature (T₁ [symbol] T₂ [symbol] T₃ . . . Tᵢ) of each output computation partition is compared with the preset temperature threshold T₀, respectively. Based on a comparison result, the controller adjusts a unit laser power corresponding to the output computation partition.

In some embodiments, the preset value is set to 2%. When the relative temperature deviation exceeds 2%, a fuzzy PID is required for control; otherwise, a traditional PID is used for control.

Three cases are known: T₀>Tᵢ, T₀<Tᵢ, and T₀=Tᵢ.

In some embodiments, when T₀>Tᵢ and

$$\frac{\vert {T}_{i} - {T}_{0} \vert}{{T}_{0}}$$

is greater than the preset value, it indicates that a thermal input of a current output computation partition is insufficient. The controller 1 determines that a heat loss exists and proceeds to step S1.3. When T₀>Tᵢ but

$$\frac{\vert {T}_{i} - {T}_{0} \vert}{{T}_{0}}$$

is less than or equal to the preset value, the controller 1 determines normal operation and repeats step S1.1.

In some embodiments, when T₀<Tᵢ and

$$\frac{\vert {T}_{i} - {T}_{0} \vert}{{T}_{0}}$$

is greater than the preset value, it indicates that a heat accumulation in a current output computation partition is too high. The controller 1 determines that an overheating risk exists and proceeds to step S1.3. When T₀<Tᵢ but

$$\frac{\vert {T}_{i} - {T}_{0} \vert}{{T}_{0}}$$

is less than or equal to the preset value, the controller 1 determines normal operation and repeats step S1.1.

In some embodiments, when T₀=Tᵢ, the controller 1 determines normal operation and repeats step S1.1.

S1.3, performing real-time adjustment on PID parameters online with the fuzzy PID, and feeding back to a sub-controller of a corresponding optical fiber of the laser emitter array.

The PID parameters refer to three core coefficients used by the controller to adjust the unit laser power, including a proportional gain kₚ, an integral coefficient kᵢ, and a derivative coefficient k_{d}.

In some embodiments, for an irradiation region corresponding to any laser beam, a temperature deviation rate

$$\frac{e}{{T}_{0}}$$

is obtained. e is a deviation between a preset temperature value and a measured value. When

$$\frac{e}{{T}_{0}}$$

is greater than a preset value, the controller performs synchronous power adjustment on a sub-controller corresponding to a laser beam adjacent to a current laser beam, and a priority of the synchronous power adjustment is higher than a priority of a corresponding PID instruction.

The preset temperature value is the temperature threshold T₀. The measured value is the average temperature Tᵢ of the output computation partition.

e=|T₀−Tᵢ|. Three cases are known: T₀>Tᵢ, T₀<Tᵢ, and T₀=Tᵢ.

In some embodiments, if T₀>Tᵢ and

$$\frac{e}{{T}_{0}}$$

is greater than the preset value, the controller determines that a risk of insufficient thermal input exists in a current output computation partition and controls a corresponding sub-controller to synchronously increase output powers of a current laser beam and a laser beam adjacent to the current laser beam. A priority of the synchronous increase is higher than a priority of a corresponding PID instruction. If T₀>Tᵢ and

$$\frac{e}{{T}_{0}}$$

is less than or equal to the preset value, the output power is not adjusted.

In some embodiments, if T₀<Tᵢ and

$$\frac{e}{{T}_{0}}$$

is greater than the preset value, the outuput power is not adjusted. If T₀<Tᵢ, and

$$\frac{e}{{T}_{0}}$$

is less than or equal to the preset value, the controller determines that an overheating risk exists in a current output computation partition and controls a corresponding sub-controller to synchronously reduce output powers of a current laser beam and a laser beam adjacent to the current laser beam. A priority of the synchronous reduction is higher than a priority of a corresponding PID instruction.

In some embodiments, if T₀=Tᵢ, the output power is not adjusted.

Some embodiments of the present disclosure employ fuzzy PID control. Based on traditional PID control, a fuzzy module is added, which enhances adaptability of the system, reduces a rise time and an adjustment time of the system, and reduces a steady-state error.

In some embodiments, a control output of a PID controller satisfies Formula (2):

$$u ( t ) = {k}_{p} e ( t ) + {k}_{i} {\int }_{0}^{t} e ( t ) dt + {k}_{d} \frac{de ( t )}{{d}_{t}} \qquad ( 2 )$$

where u(t) is a laser power adjustment amount; e(t) is the deviation between the set value and the measured value; and kₚ, kᵢ, and k_{d} are the proportional gain, the integral coefficient, and the derivative coefficient, respectively.

In some embodiments, the controller outputs the laser power adjustment amount u(t) to a corresponding sub-controller. The sub-controller adjusts a unit laser power of a corresponding laser emitter based on u(t).

In some embodiments, the fuzzy PID control adds a fuzzy module to a traditional PID control system. Using a deviation e and a rate of change of the deviation ec as inputs, the fuzzy PID outputs adjustment amounts Δkₚ, Δkᵢ, and Δk_{d} for kₚ, kᵢ, and k_{d} by utilizing fuzzy control rules, thereby adjusting the PID parameters online in real time, which satisfies Formulas (3), (4), and (5), respectively:

$$e = {T}_{0} - {T}_{i} \qquad ( 3 )$$

$$ec = \frac{de}{{d}_{t}} \qquad ( 4 )$$

$$\{ \begin{matrix}{K}_{P} = {K}_{{p}_{0}} + Δ {K}_{p} \\ {K}_{i} = {K}_{io} + Δ {K}_{i} \\ {K}_{d} = {K}_{{d}_{0}} + Δ {K}_{d}\end{matrix} \qquad ( 5 )$$

where Kₚ_{ₒ}, Kᵢₒ, and K_{d}_{ₒ}, are initial PID parameters, which are preset manually.

When the average temperature Tᵢ of the output computation partition fed back by the thermal imager meets a startup requirement of the controller, the fuzzy module of the fuzzy PID control starts to work to control the laser power. Meanwhile, the thermal imager monitors the temperature in real time and provides feedback, thereby realizing real-time input of the temperature deviation e and the rate of change of the deviation ec. Thus, the PID parameters are adjusted online in real time to achieve automatic temperature control.

In some embodiments, taking 15 sub-controllers as an example, PID control of the 15 sub-controllers is relatively independent. All the sub-controllers work in parallel, but control ranges of the sub-controllers are different. Each of the sub-controllers processes temperature change regulation for a corresponding region. However, considering that thermal interaction exists between adjacent spots, laser power adjustment by one sub-controller affects the temperature of an adjacent region. Therefore, for an irradiation region corresponding to any laser beam, a temperature deviation rate

$$\frac{e}{{T}_{0}}$$

is obtained. In practical applications, when the temperature deviation rate

$$\frac{e}{{T}_{0}}$$

of the region is >50%, synchronous power adjustment is performed on a sub-controller corresponding to a laser beam adjacent to a current laser beam, and a priority of the synchronous power adjustment is higher than a priority of a corresponding PID instruction. Otherwise, the thermal imager transmits multi-channel temperature signal data to the controller. After processing by respective sub-controllers according to a corresponding relationship, the controller outputs a plurality of control signals to control the laser power.

Finally, when the workpiece to be processed 3 reaches the coordinate (x₀+x, 0), the laser is turned off.

Some embodiments of the present disclosure solve problems such as complex transformation of spot shape during laser processing, difficulty in achieving uniform energy distribution of large-size spots, difficulty in independent control of dot-matrix spots, and difficulty in coupling a plurality of processing technologies. The beneficial effects include: (1) making the spot two-dimensional arrayed, and enabling independent stepless control of the power density of each unit spot, so that the energy distribution of the spot array and the spot shape can be precisely customized according to the shape of a complex curved surface, which not only ensures temperature uniformity on the surface of a complex component, improves the workpiece surface hardness and the uniformity of microstructure distribution, but is also applicable to a plurality of processing apparatuses; (2) for the homogenizing and shaping process of a laser spot, a microlens array homogenizing and shaping module is used to realize the rectangularization and splicing shape of unit spots, and the energy of each unit spot is uniformly distributed; (3) through an external controller, independent control of the energy of unit spots is realized.

In some embodiments, the controller is further configured to: perform real-time adjustment on the PID parameters according to a neighbor-coordinated temperature deviation e′(t), wherein the neighbor-coordinated temperature deviation e′(t) is determined based on a temperature deviation of a current channel and a temperature deviation of a neighborhood.

The neighbor-coordinated temperature deviation refers to a comprehensive temperature deviation related to the neighborhood.

The neighborhood refers to, in arrayed laser spots, a control channel corresponding to other spots that are spatially adjacent to the current unit spot. Each unit spot in the arrayed laser spots is output by a laser emitter through an independent optical fiber, and a unit laser power of each unit spot is adjusted by an independent control channel.

In some embodiments, the neighborhood is specified by manual preset. In some embodiments, two unit spots adjacent to the current unit spot on the left and right are specified as the neighborhood. For example, the neighborhood of a current channel i includes an adjacent left channel i−1 and an adjacent right channel i+1.

In some embodiments, the controller obtains a temperature deviation eᵢ(t) of the current channel i through the thermal imager, and obtains temperature deviations of the neighborhood, namely a temperature deviation eᵢ₋₁(t) of the left channel i−1 and a temperature deviation eᵢ₊₁(t) of the right channel i+1; then determines a neighbor-coordinated temperature deviation e′(t) by weighted calculation based on the temperature deviation of the current channel and the temperature deviations of the neighborhood. For example, e′(t) is determined by formula (6):

$${e}_{i}^{′} ( t ) = {w}_{i} * {e}_{i} ( t ) + {w}_{i - 1} * {e}_{i - 1} ( t ) + {w}_{i + 1} * {e}_{i + 1} ( t ) \qquad ( 6 )$$

where wᵢ, wᵢ₋₁, and wᵢ₊₁ are weighting coefficients, which are determined by manual preset.

In some embodiments, the control output of the PID controller satisfies formula (7):

$${u}_{i} ( t ) = {k}_{p} {e}^{′} ( t ) + {k}_{i} {\int }_{0}^{t} {e}^{′} ( t ) dt + {k}_{d} \frac{{de}^{′} ( t )}{{d}_{t}} \qquad ( 7 )$$

In some embodiments, the fuzzy PID takes the neighbor-coordinated temperature deviation e′(t) and a rate of change

$${ec}_{i}^{′} ( t )$$

of the neighbor-coordinated temperature deviation as inputs, and uses fuzzy control rules to output adjustment amounts Δkₚ, Δkᵢ, and Δk_{d} for kₚ, kᵢ, and k_{d}, thereby performing real-time online adjustment on the PID parameters, which respectively satisfy formulas (8), (9), and (10):

$${e}_{i} ( t ) = {T}_{0} - {T}_{i} \qquad ( 8 )$$

$${ec}_{i}^{′} ( t ) = \frac{{de}^{′} ( t )}{{d}_{t}} \qquad ( 9 )$$

$$\{ \begin{matrix}{K}_{P} = {K}_{{p}_{0}} + Δ {K}_{p} \\ {K}_{i} = {K}_{io} + Δ {K}_{i} \\ {K}_{d} = {K}_{{d}_{0}} + Δ {K}_{d}\end{matrix} \qquad ( 10 )$$

The current channel refers to a control channel corresponding to the current unit spot.

Some embodiments of the present disclosure introduce neighborhood temperature information on the basis of fuzzy PID, so that the decision of each controller is no longer isolated, which can effectively smooth a temperature field at the junction of spots, prevent adjacent controllers from pulling or oscillating due to thermal coupling, thereby improving overall temperature uniformity in a spatial dimension.

In some embodiments, the neighborhood is determined based on a physical arrangement of the laser emitter array and a regional attribute label of the current channel.

The regional attribute label refers to a discrete variable that classifies and identifies thermophysical characteristics of a processed region. In some embodiments, the regional attribute label includes a thermally sensitive region, a normal region, a thermally inert region, a scanning path edge, etc.

In some embodiments, the controller identifies the regional attribute label of the current channel in real time and determines a neighborhood participating in calculation of the neighbor-coordinated temperature deviation based on the physical arrangement of the laser emitter array and the regional attribute label.

In some embodiments, if the current channel is marked as a thermally sensitive region, then all physical neighborhoods do not participate in the calculation,

$${e}_{i}^{′} ( t ) = {e}_{i} ( t ) .$$

All physical neighborhoods refer to all control channels that are directly adjacent in spatial position to the current channel.

The physical neighborhood refers to, in the physical arrangement of the laser emitter array, a control channel that is directly adjacent in spatial position to the current channel.

In some embodiments, if the current channel is marked as a normal region, then the neighborhood includes all physical neighborhoods.

In some embodiments, if the current channel is marked as a scanning path edge, then the neighborhood only includes physical neighborhoods on a processed inner side.

The scanning path edge refers to, during the laser processing, a side where a geometric boundary of the arrayed laser spots borders an unprocessed region of the workpiece to be processed 3. For example, if the arrayed laser spots are fixed, and a workpiece platform moves along a positive direction of an X-axis, then an outer side of a spot at the farthest end in the positive direction of the X-axis is the scanning path edge.

The processed inner side refers to a region that has been processed or is being processed by the arrayed laser spots. For example, if the workpiece platform moves along the positive direction of the X-axis, then a region in a negative direction of the X-axis is the processed inner side.

In some embodiments of the present disclosure, the controller can dynamically adjust a coordinated control strategy according to different characteristics of processing regions, for example, focusing on local rapid response in the thermally sensitive region to prevent overheating, maintaining temperature uniformity in the normal region, and limiting energy diffusion to an unprocessed region at the scanning path edge to prevent local overheating, which significantly improves temperature control accuracy and adaptability for processing complex components.

In some embodiments, the controller is further configured to: acquire a historical temperature sequence of real-time temperatures of each output computation partition and a historical power sequence output by the controller; determine the regional attribute label of the current output computation partition based on the historical temperature sequence and the historical power sequence; and perform the real-time adjustment on the PID parameters based on the regional attribute label and a planned adjustment amount of the PID parameters.

The historical temperature sequence refers to a set of continuous measured temperature values arranged in chronological order for each control channel (output computation partition) within a preset historical time period. For example, a historical temperature sequence of a control channel i is expressed as {Qᵢ(t), Qᵢ(t−Δt), Qᵢ(t−2Δt), . . . }, where Δt is a sampling time interval, and Qᵢ is a real-time temperature value.

In some embodiments, the historical temperature sequence is collected in real time by the thermal imager and stored in a storage unit of the controller. In some embodiments, a length of the historical temperature sequence is set according to a specific application, typically covering a time period sufficient to reflect thermal dynamic characteristics, such as 0.5 to 2 seconds.

The historical power sequence refers to a time sequence of power control instructions sent by the controller to each sub-controller within the preset historical time period. For example, a historical power sequence of a sub-controller i is expressed as {Pᵢ(t), Pᵢ(t−Δt), Pᵢ(t−2Δt), . . . }.

The power control instruction refers to an electrical signal by which the controller drives the sub-controller to adjust an output power of the laser emitter. In some embodiments, the power control instruction includes a channel identifier i, an output power P, and a time point t.

In some embodiments, the historical power sequence is recorded by the controller and stored in the storage unit.

The planned adjustment amount of the PID parameters refers to a change value calculated by the fuzzy PID controller that needs to be added to current PID parameters.

In some embodiments, the controller obtains the historical temperature sequence and the historical power sequence from the storage unit, calculates a change amount A of the historical temperature sequence and a change amount B of the historical power sequence, and determines the regional attribute label by querying a first preset table based on A and B.

The change amount of the historical temperature sequence refers to, within the preset historical time period, a characteristic value representing an evolution trend of the historical temperature sequence collected by the current channel in a time dimension. In some embodiments, linear regression is performed on all temperature values within the preset historical time period, and a slope of a resulting fitted straight line is the change amount A of the historical temperature sequence.

The change amount of the historical power sequence refers to, within the same preset historical time period, an energy input change amount of a power instruction sequence output by the controller to the laser emitter. In some embodiments, a change amount of an average output power in a current historical time period relative to that of a previous historical time period is the change amount B of the historical power sequence.

The first preset table is a mapping relationship table among the change amount of the historical temperature sequence, the change amount of the historical power sequence, and the regional attribute label.

In some embodiments, the regional attribute label includes a thermally sensitive region, a normal region, and a thermally inert region.

In some embodiments, the arrayed laser spots are set to completely cover the thermally sensitive region, the normal region, and the thermally inert region of the workpiece to be processed. An output power P of each control channel and a temperature Q of a corresponding region measured by the thermal imager at each time point are recorded. The change amount A of the historical temperature sequence and the change amount B of the historical power sequence are calculated according to the preset historical time period. The change amount A and the change amount B of each output computation partition within a same historical time period form a feature fingerprint. The feature fingerprint is associated and labeled one-to-one with a corresponding regional attribute label. A result of the labeling is stored in the first preset table.

In some embodiments, a corresponding correction coefficient is determined by querying a second preset table according to the regional attribute label. A product of the correction coefficient and a planned adjustment amount of a PID parameter is used as a final adjustment amount of the PID parameter. The PID parameter is adjusted in real time based on the final adjustment amount. For example, when a region is labeled as the thermally sensitive region, a correction coefficient is determined to be 0.5. A product of 0.5 and the planned adjustment amount is used as the final adjustment amount. Based on this, parameter adjustment becomes more gentle to prevent overshoot.

The correction coefficient refers to a coefficient for adjusting the planned adjustment amount of the PID parameter.

The planned adjustment amount of the PID parameter refers to a laser power adjustment amount u(t) output by a PID controller.

The second preset table is a mapping relationship table between the regional attribute label and the correction coefficient. The second preset table is determined through preset historical experience.

In some embodiments of the present disclosure, by analyzing historical temperature data and historical power data, a thermal attribute of a region is identified in real time. Adjustment of the PID parameter is shifted from relying solely on an error to intelligent decision-making based on physical characteristics. The controller can significantly improve adaptability to different materials and geometric shapes by actively optimizing the control strategy, such as using gentle parameters for thermally sensitive regions to prevent overshoot and using aggressive parameters for thermally inert regions to speed up response.

In some embodiments, the controller is further configured to perform preprocessing on the historical temperature sequence and the historical power sequence to obtain preprocessed temperature sequence data and preprocessed power sequence data; determine a response coefficient Rᵢ based on the preprocessed temperature sequence data and the preprocessed power sequence data; and determine the regional attribute label based on the response coefficient Rᵢ and a grading threshold.

In some embodiments, the preprocessing includes filtering for noise removal and synchronous alignment. The filtering for noise removal refer to performing smoothing processing on the historical temperature sequence. For example, a low-pass filter is used to perform smoothing processing on the historical temperature sequence to remove high-frequency noise.

The synchronous alignment refers to aligning the historical temperature sequence with the historical power sequence on a time axis. For example, interpolation or resampling is performed on the historical temperature sequence and the historical power sequence according to sampling timestamps, so that the historical temperature sequence and the historical power sequence are aligned under a unified time step.

The response coefficient is a physical quantity that measures a degree of sensitivity of the output computation partition to a change in laser power. For example, the response coefficient is a temperature change rate of the output computation partition caused by a unit power change.

In some embodiments, a power increment ΔP is calculated for the preprocessed power sequence data. A temperature change rate dT/dt is calculated for the temperature sequence data. Linear regression analysis is performed on a sufficient number of ΔP and dT/dt to obtain a slope of a resulting fitted straight line as the response coefficient Rᵢ. The sufficient number refers to a minimum count of sampling points for which a statistical result achieves statistical confidence, for example, at least 50 consecutive sampling points.

The grading threshold refers to a parameter for performing graded discrimination on the response coefficient Rᵢ. In some embodiments, the grading threshold includes an upper limit threshold α for distinguishing the thermally sensitive region from the normal region, and a lower limit threshold β for distinguishing the thermally inert region from the normal region. In some embodiments, the upper limit threshold α and the lower limit threshold β are determined in various ways. For example, the upper limit threshold α and the lower limit threshold β are preset based on historical experience.

In some embodiments, when Rᵢ>α, the output computation partition is determined as the thermally sensitive region. When Rᵢ<β, the output computation partition is determined as the thermally inert region. When β≤Rᵢ≤α, the output computation partition is determined as the normal region.

In some embodiments of the present disclosure, by quantifying regional thermal sensitivity using a temperature-power response coefficient and achieving automatic attribute labeling in combination with the grading threshold, fuzzy physical characteristics are transformed into computable indicators, providing clear data support for control strategy switching and improving decision-making reliability.

In some embodiments, the grading threshold is determined based on a thermophysical property, a geometric feature, and a laser processing parameter of the workpiece to be processed.

The thermophysical property refers to a physical attribute inherent to a material of the workpiece to be processed that determines thermal conduction and thermal response behavior of the workpiece to be processed. In some embodiments, the thermophysical property includes a thermal conductivity, a specific heat capacity, and a thermal diffusivity.

In some embodiments, the controller obtains a material attribute of the workpiece to be processed by querying a preset material process database.

The material process database is a database preset based on experiments. The material process database is a structured data collection that records physical attribute parameters and corresponding processing process data of a plurality of processed materials. The material process database is preset manually based on experimental data.

The thermal conductivity is a physical quantity that measures an ability of a material to conduct heat. A larger value of the thermal conductivity indicates faster heat diffusion inside the material.

The specific heat capacity is a physical quantity that measures an ability of a material to store heat. A larger value of the specific heat capacity indicates a stronger buffering ability of the material against temperature changes.

The thermal diffusivity is a physical quantity that measures an ability of a material to achieve temperature uniformity. The thermal diffusivity is determined by a ratio of the thermal conductivity to a product of the specific heat capacity and density.

The geometric feature refers to a shape and a structure of the workpiece to be processed in three-dimensional space. For example, the geometric feature includes local thickness, sharp corners, edges, grooves, holes, or the like. In some embodiments, the controller obtains the geometric feature of the workpiece to be processed by parsing a three-dimensional model (e.g., a CAD model) of the workpiece to be processed.

The laser processing parameter refers to a process condition set during laser processing. In some embodiments, the controller obtains the laser processing parameter of the workpiece to be processed by querying the preset material process database.

In some embodiments, the laser processing parameter includes a spot size, a scanning speed, a base power, or the like.

The spot size is a size of the arrayed laser spot. The spot size affects an action area of laser energy and an energy density per unit area.

The scanning speed is a moving speed of the arrayed laser spots on the surface of the workpiece to be processed. The scanning speed affects a heat input amount.

The base power is a nominal output power level of the laser emitter when dynamic adjustment is not performed. The base power determines a benchmark for overall energy input.

In some embodiments, the upper limit threshold α and the lower limit threshold β of the grading threshold are determined by querying a third preset table based on the thermophysical property, the geometric feature, and the laser processing parameter of the workpiece to be processed.

The third preset table is a mapping relationship table among the upper limit value a, the lower limit value B, the thermophysical property, the geometric feature, and the laser processing parameter.

In some embodiments, the thermophysical property, the geometric feature, and the laser processing parameter of the workpiece to be processed are set. The arrayed laser spots are set to completely cover the thermally sensitive region, the thermally inert region, and the normal region of the workpiece to be processed. During a processing process, an output power P of each laser emitter and a temperature Q of a corresponding output computation partition measured by the thermal imager at each time point are recorded. The response coefficient Rᵢ is calculated in real time. After a sufficient amount of Rᵢ data is collected, for example, after at least 200 pieces of Rᵢ data is collected, the Rᵢ data is grouped and statistically analyzed according to a type to which a region belongs (the thermally sensitive region, the thermally inert region, and the normal region). The thermally sensitive region is limited by geometric features such as thin walls, resulting in slow heat dissipation, so that a distribution of response coefficients Rᵢ shifts toward a high-value region. Therefore, a lower limit (e.g., the 5% percentile) of the distribution is taken as the upper limit threshold α. The thermally inert region is influenced by properties of high thermal conductivity or features of thick solid bodies, resulting in fast heat dissipation, so that a distribution of response coefficients Rᵢ shifts toward a low-value region. Therefore, an upper limit (e.g., the 95% percentile) of the distribution is taken as the lower limit threshold β. Then, a mapping relationship is established among the thermophysical property, the geometric feature, and the laser processing parameter of the workpiece to be processed and the corresponding upper limit threshold α and lower limit threshold β, and the mapping relationship is recorded in the third preset table.

In some embodiments of the present disclosure, by associating the grading thresholds α and β with specific “material-geometry-process” combinations, the thresholds become strongly scenario-dependent empirical parameters. This ensures effectiveness and optimality of a fuzzy PID control strategy in an actual processing process and avoids generalized settings that are detached from actual working conditions.

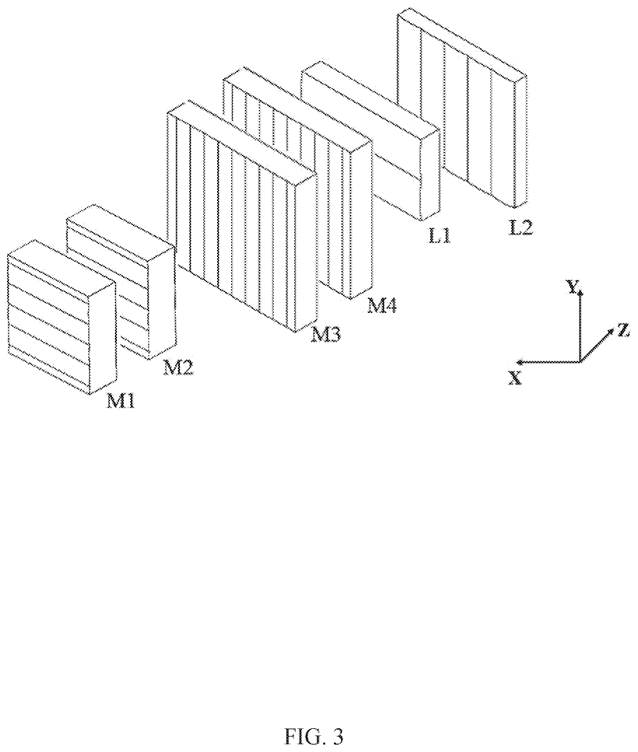

FIG. 3 is a schematic diagram of a microlens array homogenizing and shaping module according to some embodiments of the present disclosure.

As shown in FIG. 3, the microlens array homogenizing and shaping module includes a first microlens array sheet group 5, a second microlens array sheet group 6, and an array focusing lens group 7 which are sequentially and parallelly arranged; and the microlens array homogenizing and shaping module is perpendicular to a laser incidence direction of the laser emitter array 9.

The first microlens array sheet group 5 and the second microlens array sheet group 6 are optical components configured to perform shaping processes such as splitting and recombining on laser beams.

In some embodiments, the first microlens array sheet group 5 is configured to shape collimated multi-channel laser beams along an X-axis direction.

In some embodiments, the second microlens array sheet group 6 is configured to shape the collimated multi-channel laser beams along a Y-axis direction.

The array focusing lens group 7 is an optical component configured to focus laser spots. In some embodiments, the array focusing lens group 7 includes one or more focusing lenses.

In some embodiments, the array focusing lens group 7 is configured to focus arrayed laser spots formed after shaping by the first microlens array sheet group 5 and the second microlens array sheet group 6 onto a surface of a workpiece 3.

In some embodiments, the first microlens array sheet group 5, the second microlens array sheet group 6, and the corresponding array focusing lens group 7 are arranged sequentially and parallel to each other along the laser incidence direction of the laser emitter array 9.

More descriptions regarding the first microlens array sheet group 5, the second microlens array sheet group 6, and the array focusing lens group 7 may be found in related content of step S2.4.

In some embodiments of the present disclosure, after a plurality of laser beams are emitted from the laser emitter array, the plurality of laser beams sequentially pass through two parallel microlens arrays for beam splitting, overlapping, and homogenizing, and then are focused onto the surface of the workpiece by the array focusing lens group, which can form arrayed laser spots with uniform energy distribution and regular shapes.

In some embodiments, the first microlens array sheet group 5 includes one or more first one-dimensional microlens array sheets 11(12) arranged in parallel. The second microlens array sheet group 6 includes one or more second one-dimensional microlens array sheets 13(14) arranged in parallel.

In some embodiments, the first microlens array sheet group 5 includes two first one-dimensional microlens array sheets 11(12) arranged in parallel. The second microlens array sheet group 6 includes two second one-dimensional microlens array sheets 13(14) arranged in parallel. Each of the first one-dimensional microlens array sheets 11(12) and the second one-dimensional microlens array sheets 13(14) includes a plurality of elongated lenses which are parallel and uniformly distributed. The elongated lenses of the first one-dimensional microlens array sheets 11(12) and the elongated lenses of the second one-dimensional microlens array sheets 13(14) are arranged perpendicularly.

The first one-dimensional microlens array sheet 11(12) and the second one-dimensional microlens array sheet 13(14) refer to optical elements configured to perform shaping processes such as splitting and recombining on a laser beam in a single dimension.

The elongated lens refers to a transmissive material element in a narrow, elongated strip shape, for example, a long glass strip with a semicircular or circular arc cross-section.

In some embodiments, the first one-dimensional microlens array sheet 11(12) includes a plurality of elongated lenses arranged in parallel and uniformly distributed. A length direction of the elongated lenses is parallel to the Y-axis. A cross-section of the elongated lenses presents a curved shape in the X-axis direction to shape the laser beam in the X-axis direction.

In some embodiments, the second one-dimensional microlens array sheet 13(14) includes a plurality of elongated lenses arranged in parallel and uniformly distributed. A length direction of the elongated lenses is parallel to the X-axis. A cross-section of the elongated lenses presents a curved shape in the Y-axis direction to shape the laser beam in the Y-axis direction.

More descriptions regarding the first one-dimensional microlens array sheets 11(12), the second one-dimensional microlens array sheets 13(14), and the elongated lenses may be found in related content of step S2.3.

In some embodiments of the present disclosure, by using two sets of one-dimensional microlens array sheets with orthogonal light transmission directions, shaping processes such as splitting and recombining can be performed on the laser beam simultaneously in both X and Y directions, allowing each laser beam to obtain a regular and uniform spot on a two-dimensional plane.

In some embodiments, the array focusing lens group 7 includes a first array focusing lens 15 cooperating with the first microlens array sheet group 5 and a second array focusing lens 16 cooperating with the second microlens array sheet group 6. The first array focusing lens 15 and the second array focusing lens 16 are sequentially arranged and are parallel to the first microlens array sheet group 5 and the second microlens array sheet group 6.

The first array focusing lens 15 and the second array focusing lens 16 are optical elements configured to focus laser spots, e.g., focusing lenses.

The first array focusing lens 15 is configured to focus laser spots processed by the first microlens array sheet group 5 along the X direction.

The second array focusing lens 16 is configured to focus laser spots processed by the second microlens array sheet group 6 along the Y direction.

In some embodiments, the first microlens array sheet group 5, the second microlens array sheet group 6, the first array focusing lens 15, and the second array focusing lens 16 are arranged sequentially and parallel to each other.

Regarding application of the microlens array homogenizing and shaping module, the present disclosure describes the application and its steps with reference to FIG. 6.

FIG. 6 is an application flowchart of an apparatus for digital spot laser processing according to some embodiments of the present disclosure.

As shown in FIG. 6, some embodiments of the present disclosure further provide an application of the apparatus for digital spot laser processing.

In some embodiments, the apparatus for digital spot laser processing is applied to laser processing of components with symmetric heat transfer characteristics and components with asymmetric heat transfer characteristics. An application process includes the following steps.

S2.1, performing surface cleaning on the workpiece to be processed 3 to ensure the surface of the workpiece to be processed 3 meets processing requirements, placing the workpiece to be processed 3 on a processing platform, partitioning a region to be processed, and setting an arrangement of the laser emitter array 9 ranging from 1×1 to 3×5 according to a partitioning situation.

The workpiece to be processed 3 refers to a workpiece that requires laser processing, for example, a metal sheet, an alloy component, or a composite material component.

The processing platform refers to a reference platform configured to carry and fix the workpiece to be processed, for example, a multi-axis motion platform.

The region to be processed refers to a region on the surface of the workpiece to be processed that requires laser processing.

In some embodiments, the processing requirements include that the surface of the workpiece to be processed 3 is free of oil stains, oxide scales, cutting fluid residues, or the like.

In some embodiments, oil stains, dust, oxides, or the like on the surface of the workpiece to be processed 3 are cleaned by ways such as alcohol wiping or plasma cleaning, so that the workpiece to be processed 3 meets the processing requirements.

In some embodiments, the region to be processed is divided into a plurality of output computation partitions. A size of each output computation partition does not exceed a maximum size that the arrayed laser spots can cover. According to the size of each output computation partition, a count of rows and a count of columns of laser emitters in the laser emitter array 9 are set, so that the arrayed laser spots can completely cover a corresponding output computation partition in a single light emission process.

S2.2, each laser emitter of the laser emitter array 9 generating a laser beam with a cross-section generally circular, all laser beams being arranged in an array and passing through the collimation module 4 to form an array of collimated parallel beams.

The array of collimated parallel beams refers to a beam set in which each laser beam is parallel to others, and the laser beams maintain an arrayed arrangement.

In some embodiments, the controller may adjust a position in a Z-axis direction, adjust a spot size, and adjust a size of an overlapping region between unit spots. In some embodiments, the controller drives the laser processing lens to move up and down along a Z-axis relative to the processing platform, thereby changing a focal depth position and a spot diameter of the arrayed laser spot.

In some embodiments, the controller adjusts an emission deflection angle of each control channel in the laser emitter array 9 to increase or decrease the size of the overlapping region between the unit spots. For example, when an output computation partition is detected as a thermally sensitive region, the controller increases an emission deflection angle of a current channel to increase an overlapping distance between the unit spots, thereby reducing energy overlap per unit area to lower a risk of thermal deformation.

S2.3, the array of collimated parallel beams sequentially passing through the microlens array homogenizing and shaping module to form arrayed beams with rectangular unit spots, outputting the arrayed beams through the light exit port 8, forming arrayed spots arranged in a set shape on the region to be processed.

The arrayed spots refer to the arrayed laser spots. More descriptions may be found in related content of FIG. 1.

In some embodiments, the first microlens array sheet group 5 includes two first one-dimensional microlens array sheets 11(12) in an X-axis direction. The second microlens array sheet group 6 includes two second one-dimensional microlens array sheets 13(14) in a Y-axis direction. A subsequent first array focusing lens 15 is in the X-axis direction, and a subsequent second array focusing lens 16 is in the Y-axis direction.

In some embodiments, after the array of collimated parallel beams (also referred to as the arrayed collimated parallel beams) in S2.2 sequentially passes through the two first one-dimensional microlens array sheets 11(12), each unit beam in the Y-axis direction is divided into a plurality of small beams. The plurality of small beams are focused by the first array focusing lens 15 to achieve transformation from a circular spot to a uniform rectangular spot in the Y-axis direction. Similarly, the beam passes through the two second one-dimensional microlens array sheets 13(14) and the second array focusing lens 16 to achieve transformation from a circular spot to a uniform rectangular spot in the X-axis direction. Accordingly, an arrayed spot having a preset shape, such as a rectangular shape, is obtained on the processing surface of the workpiece 3.

S2.4, according to changes in the region to be processed during the processing process, the controller 1 independently controlling each laser beam of the laser emitter array 9 to obtain a corresponding arrayed spot on each region to be processed.

The independent control refers to adjusting and controlling an output power of each laser emitter to better cope with complex working conditions.

In some embodiments, in S2.4, a processing platform is controlled to move along a preset direction, and the arrayed laser spots maintain a spatial position. Meanwhile, the thermal imager is turned on to perform global temperature monitoring. In some embodiments, the thermal imager is disposed of at a side of the workpiece 3.

The preset direction is a moving direction of the processing platform relative to the apparatus for digital spot laser processing. For example, the processing platform moves along an X-axis or a Y-axis in a unidirectional or reciprocating motion direction.

In some embodiments, when a surface shape of the workpiece to be processed 3 entering a region covered by the arrayed spots changes, the controller analyzes temperature data from the thermal imager to change an arrangement and/or a shape of spots output by one or more laser beams.

In some embodiments, when a protrusion exists on the surface of the workpiece 3 and the thermal imager detects an increase in surface temperature, the controller controls a sub-controller to reduce a unit laser power of a laser emitter corresponding to a current position. The current position refers to a position where the protrusion or a depression on the surface of the workpiece 3 is located.

In some embodiments, when a depression exists on the surface of the workpiece 3 and the thermal imager detects a decrease in surface temperature, the controller controls the sub-controller to increase the unit laser power of the laser emitter corresponding to the current position.

The processing continues until the processing platform moves along the preset direction and the workpiece to be processed 3 completely leaves the region covered by the arrayed spots.

As shown in the figure, in some examples, an arrayed laser 2 (including a laser emitter and a lens 2) arranges 10 divergent laser beams emitted from 2 kW laser emitters in a 2×5 rectangular array. The 10 divergent laser beams are respectively transformed by corresponding collimating lenses 10 to form arrayed collimated parallel beams. The arrayed collimated parallel beams then pass through a microlens array homogenizing and shaping module to form a 2×5 densely arranged rectangular array beam. A surface of the workpiece to be processed 3 is 300 mm away from an exit end face of an optical fiber. Basic parameters of lenses in the microlens array homogenizing and shaping module of the example are shown in Table 1.

TABLE 1
BASIC LENS PARAMETERS

| | M1/M2 | | M3/M4 | | L1 | L2 |
|---|---|---|---|---|---|---|
| Unit Curvature | 6.5 | | 8.4 | | 78.51 | 52.34 |
| Radius/mm | | | | | | |
| Focal Length/mm | 14.5 | | 18.7 | | 150 | 100 |
| Distance to Light | 20 | 33.5 | 129 | 133.5 | 150 | 200 |
| Exit/mm | | | | | | |

During implementation, parameters of M1 and M2 (the first one-dimensional microlens array sheets) are the same. Dimension adjustment in a corresponding direction may be achieved based on a spacing between M1 and M2, facilitating adjustment of arrangement of adjacent spots. The same principle applies to M3/M4 (the second one-dimensional microlens array sheets).

L1 and L2 are the first array focusing lens 15 and the second array focusing lens 16, respectively. Data for L1 needs to refer to parameters of M1 and M2. Since a final spot size is definite, a focal length is determined by considering an overall size of a laser head. A curvature of L1 is determined accordingly. Data for L2 refers to parameters of M3 and M4. The same principle applies to other aspects.

In some embodiments, a preset array is 2×5. Therefore, L1 has two convex arcs corresponding to the “2” in the array. Similarly, L2 has five convex arcs.

The above embodiment can achieve a densely arranged array distribution of 2×5 rectangular spots each having a side length of 15 mm. Energy of each unit spot is uniformly distributed, and an energy density of each unit spot is individually adjustable.

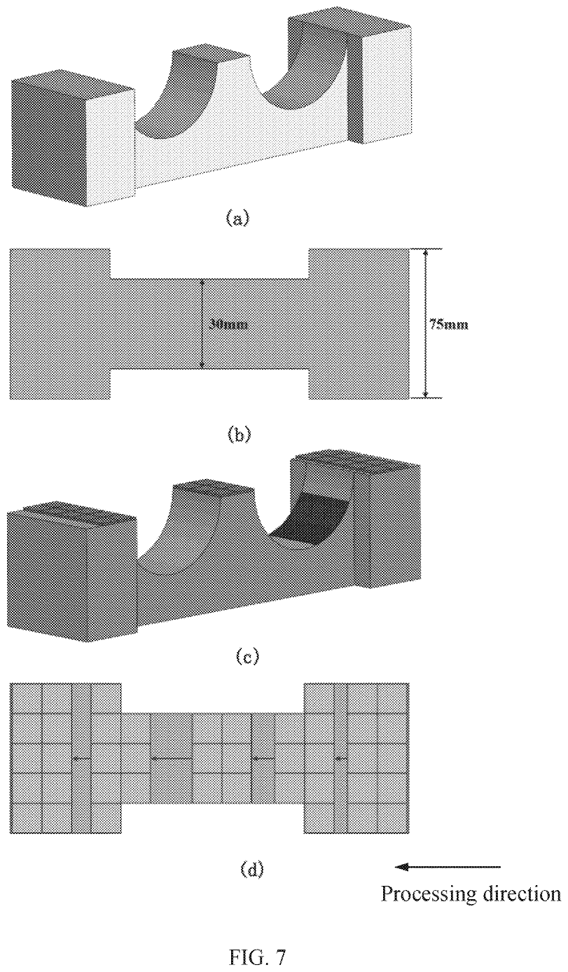

FIG. 7 is a schematic diagram of an effect of enabling or disabling unit spot light output for different regions according to some embodiments of the present disclosure, wherein (a) is an original workpiece, (b) is a top view of the original workpiece, (c) is a schematic diagram of spots in different regions of a workpiece during processing, and (d) is a top view of (c).

In some embodiments, each unit spot is rectangular.

Still taking a rectangular spot with a side length of 15 mm as an example, as shown in FIG. 7, corresponding to different positions of an I-shaped workpiece to be processed 3, the controller 1 achieves an effect of enabling or disabling unit spot light output by turning on or off different unit lasers. Accordingly, various overall spot shapes are obtained.

In some embodiments, arrayed laser spots are set to 2×5 according to a size of a surface of the workpiece to be processed 3. As the workpiece to be processed 3 moves, the arrayed laser spots irradiate a concave surface, and a size of an irradiation surface decreases. A unit laser power is gradually increased until reaching a lowest point of the workpiece to be processed 3. Meanwhile, two redundant unit lasers are turned off. Subsequently, the unit spot power is gradually decreased. When the size of the irradiation surface increases, the two unit lasers are turned on again.

In some embodiments, this way can be applied to processing of a workpiece 3 having a planar or curved surface.

The foregoing descriptions are merely preferred specific implementations of the present disclosure. However, the protection scope of the present disclosure is not limited thereto. Any person skilled in the art can easily conceive of changes or substitutions within the technical scope disclosed in the present disclosure based on the technical solutions and inventive concepts of the present disclosure. All such changes or substitutions shall fall within the protection scope of the present disclosure.

What is claimed is:

1. An apparatus for digital spot laser processing, comprising: a laser processing lens and a thermal imager arranged in coordination; wherein the laser processing lens includes:
a light entrance port, arranged in coordination with a laser emitter array for receiving laser beams from the laser emitter array;
a collimation module configured to perform a collimation process on each of the laser beams input from the light entrance port;
a microlens array homogenizing and shaping module configured to perform an output spot regularization process on each of the laser beams after the collimation process;
a light exit port configured to output processed arrayed laser spots;
wherein the light entrance port, the collimation module, the microlens array homogenizing and shaping module, and the light exit port are sequentially arranged in coordination;
a controller arranged in coordination with the laser beams from the laser emitter array and the thermal imager; wherein the controller adjusts a partitioned output of the laser emitter array based on a feedback signal from the thermal imager; the laser emitter array includes laser emitters arranged in an array, each of the laser emitters is provided with a corresponding sub-controller, and all sub-controllers corresponding to the laser emitters cooperate with the controller; for an irradiation region corresponding to any one of the laser beams, a temperature deviation rate
$$\frac{e}{{T}_{0}}$$
is acquired, where e is a deviation between a preset temperature value and a measured value, and when
$$\frac{e}{{T}_{0}}$$
is greater than a preset value, a sub-controller corresponding to a laser beam adjacent to a current laser beam performs synchronous power adjustment, and a priority of the synchronous power adjustment is higher than a priority of a corresponding proportional-integral-derivative (PID) instruction.

2. The apparatus for digital spot laser processing according to claim 1, wherein exit end faces of all of the laser emitters are flush, and all of the laser beams output from all of the laser emitters are parallel;
wherein the collimation module includes collimating lenses arranged in one-to-one correspondence and coaxial with the laser emitters, all of the collimating lenses are parallel, incidence ends of all of the collimating lenses are flush, and exit ends of all of the collimating lenses are flush;
a water cooling unit is provided for each of the laser emitters.

3. The apparatus for digital spot laser processing according to claim 2, wherein controlling an output of the sub-controller includes:
S1.1, the thermal imager acquiring in real time an average temperature Tᵢ of each output computation partition corresponding to the laser emitter array;
S1.2, based on the Tᵢ and a preset temperature threshold T₀, if
$$\frac{{T}_{i} - {T}_{0}}{{T}_{0}}$$
is greater than a preset value, proceeding to S1.3, otherwise repeating S1.1; and
S1.3, performing real-time adjustment on PID parameters online with a fuzzy PID, and feeding back to a sub-controller of a corresponding optical fiber of the laser emitter array.

4. The apparatus for digital spot laser processing according to claim 3, wherein the controller is further configured to: perform real-time adjustment on the PID parameters according to a neighbor-coordinated temperature deviation e′(t), wherein the neighbor-coordinated temperature deviation e′(t) is determined based on a temperature deviation of a current channel and a temperature deviation of a neighborhood.

5. The apparatus for digital spot laser processing according to claim 4, wherein the neighborhood is determined based on a physical arrangement of the laser emitter array and a regional attribute label of the current channel.

6. The apparatus for digital spot laser processing according to claim 3, wherein the controller is further configured to:
acquire a historical temperature sequence of real-time temperatures of each output computation partition and a historical power sequence output by the controller;
determine a regional attribute label of a current output computation partition based on the historical temperature sequence and the historical power sequence; and
perform the real-time adjustment on the PID parameters based on the regional attribute label and a planned adjustment amount of the PID parameters.

7. The apparatus for digital spot laser processing according to claim 6, wherein the controller is further configured to:
perform preprocessing on the historical temperature sequence and the historical power sequence to obtain preprocessed temperature sequence data and preprocessed power sequence data;
determine a response coefficient Rᵢ based on the preprocessed temperature sequence data and the preprocessed power sequence data; and
determine the regional attribute label based on the response coefficient Rᵢ and a grading threshold.

8. The apparatus for digital spot laser processing according to claim 7, wherein the grading threshold is determined based on a thermophysical property, a geometric feature, and a laser processing parameter of a workpiece to be processed.

9. The apparatus for digital spot laser processing according to claim 1, wherein: the microlens array homogenizing and shaping module includes a first microlens array sheet group, a second microlens array sheet group, and an array focusing lens group which are sequentially and parallelly arranged; and the microlens array homogenizing and shaping module is perpendicular to a laser incidence direction of the laser emitter array.

10. The apparatus for digital spot laser processing according to claim 9, wherein: the first microlens array sheet group includes two first one-dimensional microlens array sheets arranged in parallel, the second microlens array sheet group includes two second one-dimensional microlens array sheets arranged in parallel, each of the two first one-dimensional microlens array sheets and the two second one-dimensional microlens array sheets includes a plurality of elongated lenses which are parallel and uniformly distributed, and the elongated lenses of the first one-dimensional microlens array sheets are arranged perpendicularly to the elongated lenses of the second one-dimensional microlens array sheets.

11. The apparatus for digital spot laser processing according to claim 9, wherein: the array focusing lens group includes a first array focusing lens cooperating with the first microlens array sheet group and a second array focusing lens cooperating with the second microlens array sheet group, the first array focusing lens and the second array focusing lens are sequentially arranged and are parallel to the first microlens array sheet group and the second microlens array sheet group.
